(19) United States
(12) Patent Application Publication
(10) Pub. No.: US 2011/0206981 A1
(43) Pub. Date: Aug. 25, 2011

(54) LITHIUM SECONDARY BATTERY

(75) Inventors: Daizo Jito, Kobe-shi (JP); Maruo Kamino, Kobe-shi (JP)

(73) Assignee: SANYO ELECTRIC CO., LTD., Osaka (JP)

(21) Appl. No.: 13/006,931

(22) Filed: Jan. 14, 2011

(30) Foreign Application Priority Data
Feb. 24, 2010 (JP) 2010-038265

(51) Int. Cl. H01M 4/525; H01M 4/58

(52) U.S. Cl. 429/163

(57) ABSTRACT

A lithium secondary battery includes a positive electrode in which a positive electrode mixture layer including a positive electrode binder and a positive electrode active material containing particles of a lithium transition metal composite oxide represented by a chemical formula LiₐNi_{1-b-c}Co_{b}Al_{c}O₂ (wherein 0<a≦1.1, 0.1≦b≦0.3, and 0.03≦c≦0.10) is disposed on a surface of a positive electrode current collector, a negative electrode including a negative electrode active material containing silicon particles and/or silicon alloy particles, a separator disposed between the positive electrode and the negative electrode, a battery case, and a non-aqueous electrolyte, the positive electrode, the negative electrode, and the separator constituting an electrode body that is disposed in the battery case, wherein a lithium-containing oxide having a carbon-dioxide-gas-absorbing capability adheres to the surfaces of the particles of the lithium transition metal composite oxide.

### CROSS REFERENCE TO RELATED APPLICATIONS

This application claims priority to Japanese Patent Application No. 2010-038265 filed in the Japan Patent Office on Feb. 24, 2010, the entire contents of which are incorporated herein by reference.

### BACKGROUND OF THE INVENTION

1. Field of the Invention

The present invention relates to a lithium secondary battery including a positive electrode containing a lithium transition metal composite oxide functioning as a positive electrode active material, and a negative electrode containing particles of silicon and/or a silicon alloy functioning as a negative electrode active material.

2. Description of Related Art

Recently, as a novel high-output, high-energy-density secondary battery, a lithium secondary battery has been used in which charging and discharging are performed by using a non-aqueous electrolyte solution to transfer lithium ions between a positive electrode and a negative electrode.

Because of its high energy density, such a lithium secondary battery is used in practice as a power supply of electronic mobile devices related to information technology, such as mobile phones and notebook personal computers, and such usage is widespread. It is believed that, because of further reduction in the size and enhancement of the functions of these mobile devices, the load on a lithium secondary battery used as a power supply will increase in the future. Thus, the requirement for realizing lithium secondary batteries with a high energy density is very high.

In order to realize batteries with high energy density, it is effective to use, as an active material, a material having a higher energy density. Recently, in lithium secondary batteries, it has been proposed that an alloy material of an element, such as aluminum (Al), tin (Sn), or silicon (Si), which occludes lithium by an alloying reaction with lithium, be used as a negative electrode active material having a higher energy density instead of graphite, which has been practically used. Many of such alloy materials have been studied.

However, in an electrode in which a material that forms an alloy with lithium is used as an active material, since the volume of the active material increases or deceases at the time of the occlusion and release of lithium, the negative electrode active material may become pulverized or the negative electrode active material may become detached from a current collector. As a result, a current-collecting performance in the electrode decreases, and charge-discharge cycle characteristics become very poor.

Consequently, it has been found that, in order to achieve a high current-collecting performance in an electrode, a negative electrode obtained by sintering a negative electrode mixture layer containing a negative electrode binder and a negative electrode active material composed of a material containing silicon in a non-oxidizing atmosphere, and arranging the baked body exhibits satisfactory charge-discharge cycle characteristics to a certain extent (refer to Japanese Published Unexamined Patent Application No. 2002-260637 (Patent Document 1)). However, it is difficult to significantly improve the charge-discharge cycle characteristics.

In consideration of the above, when a negative electrode active material containing silicon is used, a positive electrode active material containing lithium carbonate (Li₂CO₃) is used so that the positive electrode active material is decomposed during charging to generate carbon dioxide gas (CO₂). It has been found that, in this case, lithium occlusion/release reactions on a surface of the negative electrode active material are smoothly performed, and side reactions are suppressed, thus exhibiting further improved charge-discharge cycle characteristics (refer to Japanese Published Unexamined Patent Application No. 2008-243661 (Patent Document 2)).

However, the potential of silicon at the time of the occlusion and release of lithium is higher than that of a graphite material or lithium metal. Accordingly, in a battery in which silicon is used as a negative electrode active material, the potential of the positive electrode becomes higher than that in the case where lithium metal or a carbon material is used as the negative electrode active material. Therefore, in the battery in which silicon is used as the negative electrode active material, the reactivity between a positive electrode active material and a non-aqueous electrolyte solution increases, and thus side reactions and the like easily occur. In addition, it is difficult to significantly improve the cycle characteristics by merely incorporating lithium carbonate in the positive electrode active material.

In view of the above problem, it has been proposed that a negative electrode containing silicon is combined with a positive electrode including, as a positive electrode active material, a lithium transition metal compound oxide containing a large amount of nickel, the lithium transition metal compound oxide having an energy density higher than that of lithium cobalt compound oxide. Such a lithium transition metal compound oxide containing a large amount of nickel easily produces lithium carbonate by a reaction with carbon dioxide gas in the atmosphere, and thus is a positive electrode active material with which the effect of improving the cycle characteristics described in Patent Document 2 can be further expected.

However, even in this configuration, the effect of generating carbon dioxide gas during charging is not sufficient, and in addition, it is difficult to suppress a reaction between the positive electrode active material and the non-aqueous electrolyte solution. Accordingly, it is difficult to significantly improve the cycle characteristics.

It has also been found that, in order to decrease the reactivity between the lithium transition metal composite oxide and an electrolyte solution, a coating layer containing a compound oxide containing lithium and titanium as main components is formed on the surfaces of positive electrode active material particles, thereby improving high-temperature characteristics (refer to Japanese Patent No. 4061648 (Patent Document 3)). However, Patent Document 3 does not describe in detail the effect in the case where such a positive electrode is combined with a negative electrode containing silicon, and it is unclear whether or not the cycle characteristics are improved when silicon, which causes an increase in the potential of the positive electrode, is used as the negative electrode active material.

### BRIEF SUMMARY OF THE INVENTION

It is desirable to provide a lithium secondary battery in which charge-discharge cycle characteristics can be significantly improved when a material containing silicon is used as a negative electrode active material and a lithium transition metal composite oxide is used as a positive electrode.

An aspect of the present invention provides a lithium secondary battery including a positive electrode in which a positive electrode mixture layer including a positive electrode binder and a positive electrode active material containing particles of a lithium transition metal composite oxide represented by a chemical formula LiₐNi_{1-b-c}Co_{b}Al_{c}O₂ (wherein 0<a≦1.1, 0.1≦b≦0.3, and 0.03≦c≦0.10) is disposed on a surface of a positive electrode current collector; a negative electrode including a negative electrode active material containing silicon particles and/or silicon alloy particles; a separator disposed between the positive electrode and the negative electrode; a battery case; and a non-aqueous electrolyte, the positive electrode, the negative electrode, and the separator constituting an electrode body that is disposed in the battery case, wherein a lithium-containing oxide having a carbon-dioxide-gas-absorbing capability adheres to the surfaces of the particles of the lithium transition metal composite oxide.

According to the above configuration, the following operations and effects can be achieved.

(a) Since the lithium-containing oxide has a carbon-dioxide-gas-absorbing capability, degradation of the negative electrode active material composed of silicon particles or the like can be suppressed.
(b) Since the lithium-containing oxide adheres to the surfaces of the particles of the lithium transition metal composite oxide, side reactions between the positive electrode active material and a non-aqueous electrolyte solution and the like can be suppressed.

The positive electrode active material in the present invention satisfies the relationships 0.1≦b≦0.3 and 0.03≦c≦0.10 in the chemical formula. Accordingly, a main component of the transition metals in the positive electrode active material is nickel, whereby a high capacity of the positive electrode can be realized. Furthermore, since the amount of nickel component is large, Li₂CO₃ is easily produced. Thus, lithium occlusion/release reactions on the surface of the negative electrode active material can be smoothly performed, and the effect of suppressing the side reactions can be more significantly exhibited.

However, the volume of a material containing silicon is significantly increased during charging and discharging, and thus the surface area of the negative electrode active material is increased. Therefore, only the effect of improving the cycle characteristics achieved by lithium carbonate (Li₂CO₃) contained in the lithium transition metal composite oxide is not sufficiently high yet. Consequently, when a lithium-containing oxide having a carbon-dioxide-gas-absorbing capability adheres to the surface of the positive electrode active material, in a process of preparing a battery, the lithium-containing oxide absorbs carbon dioxide gas in the atmosphere and reacts with the carbon dioxide gas, thereby producing a large amount of lithium carbonate. As a result, the amount of lithium carbonate in the positive electrode increases, thus significantly improving cycle characteristics.

A description will be made by taking a case where Li₂TiO₃ is used as the lithium-containing oxide as an example. In this Li₂TiO₃, the reaction represented by formula (I) below occurs. In this case, at a temperature of 310° C. or lower, the reaction proceeds in the right direction of formula (I), but the temperature in the preparation of the battery does not increase to 120° C. or higher even in a drying process. Accordingly, it is believed that when Li₂TiO₃ contacts CO₂ in the atmosphere in the process of preparing a battery, a reaction that produces lithium carbonate occurs.

Li₂TiO₃+CO₂ [symbol] TiO₂+Li₂CO₃ (I)

When a large amount of lithium carbonate is produced in the process of preparing a battery in this manner, when charging is performed (when lithium is released from the positive electrode active material and the potential of the positive electrode is increased), lithium carbonate is decomposed by this high potential to generate carbon dioxide gas (CO₂). This carbon dioxide gas smoothly causes the lithium occlusion/release reactions on the surface of the negative electrode active material and can suppress the occurrence of side reactions. Thus, the degradation (increase in the volume) of the negative electrode is suppressed, as described in (a) above. Furthermore, according to the above configuration, since the lithium-containing oxide adheres to the surfaces of the particles of the lithium transition metal composite oxide (i.e., since the lithium-containing oxide is in contact with the positive electrode active material), carbon dioxide gas is generated with certainty when the potential of the positive electrode increases. Thus, the degradation of the negative electrode can be reliably suppressed.

In addition, when a material containing silicon is used as the negative electrode, a reaction between the positive electrode and the non-aqueous electrolyte solution easily occurs because the potential of the positive electrode increases as described above. However, as in the configuration described above, when the lithium-containing oxide adheres to the surfaces of the particles of the lithium transition metal composite oxide, the contact area between the positive electrode active material and the non-aqueous electrolyte solution decreases. As a result, side reactions between the positive electrode active material and the non-aqueous electrolyte solution and the like can be suppressed, as described in (b) above.

In order to realize a high capacity of the positive electrode and to produce a larger amount of lithium carbonate, more preferably, the values of b and c in the chemical formula LiₐNi_{1-b-c}Co_{b}Al_{c}O₂ satisfy the relationships 0.15≦b≦0.25 and 0.03≦c≦0.05.

Furthermore, besides particles of elemental silicon, particles containing a silicon alloy can also be used as the negative electrode active material. Examples of the silicon alloy includes solid solutions of silicon and another one or more elements, intermetallic compounds of silicon and another one or more elements, and eutectic alloys of silicon and another one or more elements.

A ratio of the lithium-containing oxide to transition metals in the lithium transition metal composite oxide is preferably 0.1% by mole or more and 1.0% by mole or less.

When the ratio of the lithium-containing oxide to the transition metals in the lithium transition metal composite oxide is less than 0.1% by mole, the effect of suppressing side reactions between the surface of the positive electrode and the electrolyte solution, and the effect of suppressing the degradation of the negative electrode may not be sufficiently achieved. On the other hand, when the ratio exceeds 1.0% by mole, diffusion of lithium may not be smoothly performed, and thus the discharging characteristics of the positive electrode may decrease.

The lithium-containing oxide is preferably Li₂TiO₃.

The absorbing capability of carbon dioxide gas varies depending on the type of lithium-containing oxide. The use of Li₂TiO₃ can minimize the effect on the discharging characteristics of the positive electrode because Li₂TiO₃ reacts with carbon dioxide gas at a temperature of 120° C. or lower (i.e., in formula (I) above, the reaction smoothly proceeds in the right direction), Li₂TiO₃ absorbs a large amount of carbon dioxide gas per weight (i.e., the amount of Li₂TiO₃ added may be small), and Li₂TiO₃ has a high density (i.e., the volume occupying the positive electrode may be small).

However, the lithium-containing oxide used in the present invention is not limited to Li₂TiO₃ and other substances having a carbon-dioxide-gas-absorbing capability, such as LiAlO₂, LiFeO₂, Li₂SiO₃, Li₄SiO₄, and Li₂ZrO₃ (refer to, for example, Japanese Patent No. 3420036 (Patent Document 4), which is herein incorporated by reference) may be appropriately selected and used so long as charge/discharge reactions are not adversely affected.

The non-aqueous electrolyte preferably contains CO₂.

When the non-aqueous electrolyte contains CO₂, the effect of improving the cycle characteristics can be achieved similarly to the lithium-containing oxide contained in the positive electrode. Therefore, when the effect achieved by the lithium-containing oxide contained in the positive electrode is insufficient, the CO₂ can compensate for the insufficiency.

The silicon particles and/or the silicon alloy particles preferably have an average particle diameter of 7 μm or more and 17 μm or less.

In the case where the average particle diameter of negative electrode active material particles is less than 7 μm, the original silicon active material before charging and discharging has a large surface area. Therefore, when cracking of the silicon active material proceeds with the progress of charge-discharge cycles, the amount of increase in the surface area is also large, and thus the effect of the addition of the lithium-containing oxide contained in the positive electrode decreases. Accordingly, in order to achieve the effect of the addition of the lithium-containing oxide to the maximum, the average particle diameter of the negative electrode active material particles is preferably 7 μm or more.

On the other hand, when the average particle diameter of the negative electrode active material particles exceeds 17 μm, the absolute amount of increase in the volume during lithium occlusion per negative electrode active material particle increases and a deformation of a negative electrode binder, which has a function of adhesion in a negative electrode active material layer, also increases. Therefore, breaking of the negative electrode binder easily occurs, thereby decreasing the current-collecting performance. As a result, the charge/discharge characteristics decrease. Accordingly, the average particle diameter of the negative electrode active material particles is preferably 17 μm or less.

The silicon particles and/or the silicon alloy particles preferably have a crystallite size of 1 nm or more and 100 nm or less.

When the crystallite size of the silicon particles or the like is 100 nm or less, because of the small size of crystallite relative to the particle diameter, a large number of crystallites are present in the particle. In this case, since the orientations of the crystallites are disordered, polycrystalline silicon particles or the like having such a small crystallite size have a structure in which cracks are not easily generated, as compared with single-crystal silicon particles or the like.

In addition, when the crystallite is small; 100 nm or less, because of the small size of the crystallite relative to the diameter of silicon particles or the like, a large number of grain boundaries functioning as paths of lithium are present inside the silicon particles or the like. Accordingly, during charging and discharging, transfer of lithium to the inside of the silicon particles or the like is easily caused by grain boundary diffusion of lithium, and the reaction uniformity inside the silicon particles or the like becomes very high. As a result, the change in the volume inside the silicon particles or the like is uniform throughout each particle, thereby suppressing cracking of the silicon particles or the like due to the generation of a large distortion inside the silicon particles or the like.

When the generation of cracking of silicon particles or the like is suppressed in this manner, an increase in the surface area of the silicon particles or the like can be prevented. Accordingly, the effect of the addition of the lithium-containing oxide can be achieved to the maximum, and the cycle characteristics can be further improved. Furthermore, when the generation of cracking of silicon particles or the like is suppressed, it is also possible to suppress an increase in a newly formed surface having a high reactivity with a non-aqueous electrolyte solution during the charge/discharge reactions and to suppress degradation (increase in the volume) of active material particles on the newly formed surface due to a side reaction with the non-aqueous electrolyte solution. Accordingly, the charge-discharge cycle characteristics can be improved also from this standpoint.

On the other hand, the reason why the crystallite size of the silicon particles or the like is 1 nm or more is that it is difficult to prepare particles having a crystallite size of less than 1 nm even by a method of thermally decomposing a silane compound or the like.

A method for producing a lithium secondary battery according to another aspect of the present invention includes the steps of causing a lithium-containing oxide having a carbon-dioxide-gas-absorbing capability to adhere to the surfaces of particles of a lithium transition metal composite oxide represented by a chemical formula LiₐNi_{1-b-c}Co_{b}Al_{c}O₂ (where 0<a≦1.1, 0.1≦b≦0.3, and 0.03≦c≦0.10) by adding the lithium-containing oxide to the particles of the lithium transition metal composite oxide and sintering the resulting mixture; preparing a positive electrode by disposing a positive electrode mixture layer including a binder and a positive electrode active material containing the particles of the lithium transition metal composite oxide on a surface of a positive electrode current collector; preparing an electrode body by disposing a separator between the positive electrode and a negative electrode including a negative electrode active material containing silicon particles and/or silicon alloy particles; and arranging the electrode body in a battery case.

As for the method for causing the lithium-containing oxide having the carbon-dioxide-gas-absorbing capability to adhere to the surface of the lithium transition metal composite oxide, preferably, the lithium-containing oxide having the carbon-dioxide-gas-absorbing capability is added to the lithium transition metal composite oxide, the resulting mixture is mixed, and the mixture is then sintered. In this case, the sintering temperature is preferably in the range of 300° C. to 700° C. When the sintering temperature is too low, the adhesion force to the lithium transition metal composite oxide is weak, and the lithium-containing oxide may be detached in a step of preparing a slurry. On the other hand, when the sintering temperature is too high, oxygen is released from the lithium transition metal composite oxide, and degradation of the crystal structure is caused by the oxygen release, which may adversely affect the discharging characteristics.

### Other Points

(1) A solvent of the non-aqueous electrolyte in the present invention is not particularly limited. Examples of the solvent that can be used include cyclic carbonates such as ethylene carbonate, propylene carbonate, butylene carbonate, and vinylene carbonate; chain carbonates such as dimethyl carbonate, methyl ethyl carbonate, and diethyl carbonate; and esters such as methyl acetate, ethyl acetate, propyl acetate, methyl propionate, ethyl propionate, and γ-butyrolactone; ethers such as 1,2-dimethoxyethane, 1,2-diethoxyethane, tetrahydrofuran, 1,2-dioxane, and 2-methyltetrahydrofuran; nitriles such as acetonitrile; and amides such as dimethylformamide. These may be used alone or in combination of two or more solvents. In particular, mixed solvents of a cyclic carbonate and a chain carbonate can be preferably used.

(2) A solute of the non-aqueous electrolyte in the present invention is not particularly limited. Examples of the solute that can be used include compounds represented by a chemical formula LiXF_{y} (wherein X is P, As, Sb, B, Bi, Al, Ga, or In, when X is P, As, or Sb, y is 6, and when X is B, Bi, Al, Ga, or In, y is 4) such as LiPF₆, LiBF₄, LiAsF₆; and lithium compounds such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiClO₄, Li₂B₁₀Cl₁₀, and Li₂B₁₂Cl₁₂. Among these compounds, LiPF₆ is preferably used.

(3) Preferably, the non-aqueous electrolyte in the present invention further contains fluoroethylene carbonate. Carbonates containing a fluorine (F) element (such as fluoroethylene carbonate) have an effect of smoothly causing a reaction with lithium on the surface of a silicon active material during charging and discharging, similarly to carbon dioxide gas. Accordingly, the reaction uniformity is improved, and an increase in the volume of the silicon active material is suppressed. Therefore, good charge-discharge cycle characteristics can be realized.

According to the above aspects of the present invention, when a material containing silicon is used as the negative electrode active material and a lithium transition metal composite oxide is used as the positive electrode, the charge-discharge cycle characteristics can be significantly improved. Thus, a significant advantage can be achieved by the aspects of the present invention.

### DETAILED DESCRIPTION OF THE INVENTION

A lithium secondary battery according to the present invention will now be described. The lithium secondary battery according to the present invention is not limited to the lithium secondary battery of the embodiments described below, and can be implemented with modifications without departing from the spirit of the present invention.

### Preparation of Positive Electrode

First, lithium hydroxide (LiOH) and a composite hydroxide [Ni_{0.80}Co_{0.17}Al_{0.03}(OH)₂] containing nickel as a main component of a metal element were mixed with an Ishikawa-type Raikai mortar such that the molar ratio of LiOH to the composite hydroxide was 1.05:1. The mixture was then heat-treated in an oxygen atmosphere at 720° C. for 20 hours, and was then pulverized. Thus, a lithium transition metal composite oxide (positive electrode active material) represented by Li_{1.05}Ni_{0.80}Co_{0.17}Al_{0.03}O₂ and having an average particle diameter of about 10 μm was prepared.

Next, Li₂TiO₃ (lithium titanium compound oxide) was added to Li_{1.05}Ni_{0.80}Co_{0.17}Al_{0.03}O₂ prepared as described above such that the amount of titanium (Ti) was 0.3% by mole relative to the total molar amount of nickel (Ni), cobalt (Co), and aluminum (Al). The mixture was then heat-treated in an oxygen atmosphere at 400° C. for 10 hours, and was then pulverized. Thus, Li_{1.05}Ni_{0.80}Co_{0.47}Al_{0.03}O₂ in which Li₂TiO₃ adhered on the surface thereof was prepared.

Subsequently, polyvinylidene fluoride functioning as a binder was dissolved in N-methyl-2-pyrrolidone (NMP) functioning as a dispersion medium. Furthermore, the positive electrode active material, in which Li₂TiO₃ adhered on the surface thereof, and carbon functioning as an electrically conductive agent were added to the solution such that the mass ratio positive electrode active material (including Li₂TiO₃):electrically conductive agent:binder was 95:2.5:2.5, and the mixture was then kneaded to prepare a positive electrode slurry. Lastly, this positive electrode slurry was applied onto an aluminum foil functioning as a positive electrode current collector and then dried. The aluminum foil was rolled with a rolling roller, and a current collector tab was further attached to the aluminum foil. Thus, a positive electrode in which a positive electrode mixture layer is formed on both surfaces of the positive electrode current collector was prepared.

### Preparation of Negative Electrode

First, a polycrystalline silicon ingot was prepared by a thermal reduction method. Specifically, a silicon core placed in a metal reacting furnace (reducing furnace) was heated by electric heating to 800° C. A gas prepared by mixing a vapor of a purified high-purity monosilane (SiH₄) gas and purified hydrogen was supplied to the silicon core, thereby precipitating polycrystalline silicon on the surface of the silicon core. Thus, a polycrystalline silicon ingot was prepared in the form of a thick bar.

Next, this polycrystalline silicon ingot was pulverized and then classified, thus preparing polycrystalline silicon particles (negative electrode active material) having a purity of 99%. These polycrystalline silicon particles have a crystallite size of 32 nm and an average particle diameter of 10 μm.

The crystallite size was calculated by the Scherrer formula using the full width at half maximum of a (111) peak of silicon in powder X-ray diffractometry, and the average particle diameter was determined by a laser diffraction method.

Next, the negative electrode active material prepared above, a graphite powder functioning as a negative electrode electrically conductive agent and having an average particle diameter of 3.5 μm, and a varnish (solvent: NMP, concentration: 47% by mass in terms of the amount of a polyimide resin after polymerization and imidization by heat treatment) which functions as a negative electrode binder and which is a precursor of a thermoplastic polyimide resin having a molecular structure represented by chemical formula (1) below and having a glass transition temperature of 300° C. and a weight-average molecular weight of 50,000 were mixed with NMP functioning as a dispersion medium such that the mass ratio negative electrode active material powder:negative electrode electrically conductive agent powder:polyimide resin after imidization was 100:3:8.6. Thus, a negative electrode mixture slurry was prepared. The varnish which is a precursor of the polyimide resin can be prepared from diethyl 3,3′,4,4′-benzophenone tetracarboxylate represented by chemical formula (2) below and m-phenylenediamine represented by chemical formula (3) below. Diethyl 3,3′,4,4′-benzophenone tetracarboxylate can be prepared by allowing 2 equivalents of ethanol to react with 3,3′,4,4′-benzophenone tetracarboxylic acid dianhydride represented by chemical formula (4) below in the presence of NMP.

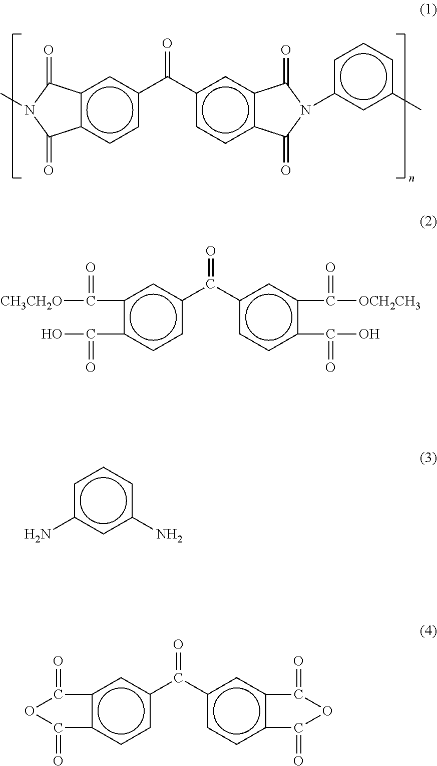

The negative electrode mixture slurry was then applied onto both surfaces of a negative electrode current collector composed of a copper alloy foil having a thickness of 18 μm (C7025 alloy foil having a composition of 96.2% by mass of copper (Cu), 3.0% by mass of nickel (Ni), 0.65% by mass of silicon (Si), and 0.15% by mass of magnesium (Mg)) that had been roughened by electrolysis so as to have a surface roughness Ra (defined by JIS B 0601-1994) of 0.25 μm and a mean spacing of local peaks of the profile S (defined by JIS B 0601-1994) of 0.85 μm. This coating was conducted in air at 25° C. Subsequently, the copper alloy foil was dried in air at 120° C. and then rolled in air at 25° C. Lastly, the resulting copper alloy foil was heat-treated in an argon atmosphere at 400° C. for 10 hours, and a negative electrode current collector tab was attached to the copper alloy foil. Thus, a negative electrode in which a negative electrode mixture layer was formed on both surfaces of the negative electrode current collector was prepared.

### Preparation of Non-Aqueous Electrolyte Solution

A solvent was prepared by mixing ethylene carbonate (EC) with methyl ethyl carbonate (MEC) in a volume ratio EC:MEC of 3:7. Lithium hexafluorophosphate (LiPF₆) was dissolved in the mixed solvent so that the concentration was 1 mol/L. Carbon dioxide gas was then dissolved in this solution by bubbling until the solution was saturated with carbon dioxide gas. Thus, a non-aqueous electrolyte solution was prepared.

### Preparation of Battery

The positive electrode and the negative electrode thus obtained were wound so as to face each other, with a separator therebetween, to prepare a wound body. The wound body was enclosed in an aluminum laminate together with the non-aqueous electrolyte solution in a glove box in a carbon dioxide (CO₂) atmosphere. Thus, a lithium secondary battery having a battery standard size of a thickness of 3.6 mm, a width of 3.5 cm, and a length of 6.2 cm was obtained. Note that when this battery is charged up to 4.20V, the design capacity is 800 mAh.

### EXAMPLES

### Main Experiments

### Example

A battery prepared by the same method as that described in the detailed description of the invention was used as a battery of Example.

The battery thus prepared is hereinafter referred to as “Invention battery A”.

### Comparative Example

A battery was prepared as in Example except that instead of Li₂TiO₃, TiO₂ was used as the substance that was caused to adhere to the surface of the positive electrode active material. When Li_{1.05}Ni_{0.80}CO_{0.17}Al_{0.03}O₂ was mixed with TiO₂, TiO₂ was added such that the amount of Ti was 0.2% by mole relative to the total molar amount of Ni, Co, and Al.

The battery thus prepared is hereinafter referred to as “Comparative battery Z”.

### Experiment

Charging and discharging were performed using Invention battery A and Comparative battery Z under the charge-discharge cycle conditions described below, and an initial discharge capacity (discharge capacity in the first cycle) and a capacity retention ratio after 300 cycles represented by formula (II) below were examined. The results are shown in Table 1. The capacity retention ratio after 300 cycles is represented as an index number, where the capacity retention ratio of Invention battery A is given a value of 100.

### Charge-Discharge Cycle Conditions

### •Charge Condition

Charging was conducted at a constant current of 800 mA (1.0 It) until the battery voltage was increased to 4.2 V, and charging was then conducted at a constant voltage of 4.2 V until the current value was increased to 40 mA (1/20 It).

### •Discharge Condition

Discharging was conducted at a current of 800 mA (1.0 It) until the battery voltage was decreased to 2.75 V.

### •Temperature

Room temperature (25° C.)

Capacity retention ratio after 300 cycles (%)=(discharge capacity in the 300th cycle/discharge capacity in the first cycle)×100 (II)

TABLE 1

| | | Capacity retention |
|---|---|---|
| | Initial discharge capacity | ratio after |
| Type of battery | (mAh) | 300 cycles* |
| Invention battery A | 754.2 | 100 |
| Comparative battery Z | 753.0 | 88.1 |

*Index Number where the capacity retention ratio of Invention battery A is given a value of 100

As is apparent from Table 1, the capacity retention ratio after 300 cycles of Invention battery A, in which Li₂TiO₃ adheres to the surface of the positive electrode active material, is improved by 10% or more, as compared with Comparative battery Z, in which TiO₂ adheres to the surface of the positive electrode active material. On the other hand, the initial discharge capacity of Invention battery A is substantially the same as that of Comparative battery Z. Thus, according to the present invention, the cycle characteristics can be improved while maintaining the initial capacity (without affecting discharge characteristics).

Furthermore, according to the above results, the following is found: Even when Li₂CO₃ is generated by using a positive electrode active material containing nickel as a main component of a transition metal and a non-aqueous electrolyte solution prepared by dissolving carbon dioxide gas until the solution is saturated with carbon dioxide gas is used, the cycle characteristics cannot be significantly improved in the case where the surface of the positive electrode active material is covered with a substance that does not have a carbon-dioxide-gas-absorbing capability. Only when the surface of the positive electrode active material is covered with a substance having a carbon-dioxide-gas-absorbing capability, the cycle characteristics can be significantly improved.

The reason why the amount of Li₂TiO₃ added in Invention battery A is different from the amount of TiO₂ added in Comparative battery Z is based on the following consideration: In the comparison between the particle diameter of Li₂TiO₃ and that of TiO₂, the particle diameter of Li₂TiO₃ was larger than that of TiO₂. Accordingly, even when Li₂TiO₃ and TiO₂ are added in the same amount, the effect may be different. Although not shown in Table 1, it was confirmed by an experiment that, even when 0.2% of Li₂TiO₃ was added (even when the amount of Li₂TiO₃ added in Invention battery A was the same as the amount of TiO₂ added in Comparative battery Z), the effect of improving the cycle characteristics could be achieved to a certain extent.

### [Reference Experiments]

In reference experiments described below, it was verified whether or not the cycle characteristics could be improved by causing Li₂TiO₃ to adhere to the surface of the positive electrode active material also in the case where graphite negative electrode was used as the negative electrode.

### Reference Example 1

A battery was prepared as in Example of the above main experiments except that a negative electrode and a non-aqueous electrolyte solution which were prepared as described below were used, and a wound body was enclosed in an aluminum laminate together with the non-aqueous electrolyte solution in a glove box in an argon (Ar) atmosphere.

The battery thus prepared is hereinafter referred to as “Reference battery X1”.

### Preparation of Negative Electrode

First, carboxymethylcellulose functioning as a thickener was dissolved in water to prepare an aqueous solution. Artificial graphite functioning as a negative electrode active material and styrene-butadiene rubber functioning as a binder were added to the aqueous solution such that the mass ratio negative electrode active material:binder:thickener was 97.5:1.5:1. The mixture was then kneaded to prepare a negative electrode slurry. Next, this negative electrode slurry was applied onto a copper foil functioning as a negative electrode current collector and dried. The copper foil was then rolled using a rolling roller, and a negative electrode current collector tab was attached to the copper foil. Thus, a negative electrode was prepared.

### Preparation of Non-Aqueous Electrolyte Solution

A solvent was prepared by mixing ethylene carbonate (EC), methyl ethyl carbonate (MEC), and diethyl carbonate (DEC) in a volume ratio EC:MEC:DEC of 2:5:3. Lithium hexafluorophosphate (LiPF₆) was dissolved in the mixed solvent so that the concentration was 1.2 mol/L. Vinylene carbonate (VC) was further added and dissolved in the solution in an amount of 2.0% by mass relative to the total amount of the electrolyte solution. Thus, a non-aqueous electrolyte solution was prepared.

### Reference Example 2

A battery was prepared as in Reference Example 1 except that instead of Li₂TiO₃, TiO₂ was used as the substance that was caused to adhere to the surface of the positive electrode active material.

The battery thus prepared is hereinafter referred to as “Reference battery X2”.

### Experiment

The capacity retention ratios after 300 cycles in Reference batteries X1 and X2 were examined. The results are shown in Table 2. The charge-discharge conditions were the same as those of the experiment in the above main experiments. The capacity retention ratio after 300 cycles is represented as an index number when the capacity retention ratio of Reference battery X1 is assumed to be 100.

TABLE 2

| Type of battery | Capacity retention ratio after 300 cycles* |
|---|---|
| Reference battery X1 | 100 |
| Reference battery X2 | 98.7 |

*Index Number where the capacity retention ratio of Reference battery X1 is given a value of 100

As is apparent from Table 2, there is no significant difference in the capacity retention ratio between Reference battery X1, in which Li₂TiO₃ adheres to the surface of the positive electrode active material, and Reference battery X2, in which TiO₂ adheres to the surface of the positive electrode active material.

According to the above experimental results, in the case where Li₂TiO₃ is caused to adhere to the surface of the positive electrode active material, when silicon and/or silicon alloy particles are used as the negative electrode, the effect of improving the cycle characteristics can be achieved, whereas when graphite is used as the positive electrode, the effect of improving the cycle characteristics is not achieved. Thus, in the case of the carbon negative electrode, with which the effect of smoothly causing the lithium occlusion/release reactions using carbon dioxide gas cannot be achieved, the effect of improving the cycle characteristics is not achieved even when the positive electrode structure of the present invention is used. The effect obtained by using the positive electrode structure of the present invention can be achieved only in the case where silicon and/or silicon alloy particles, with which the effect of smoothly causing the lithium occlusion/release reactions using carbon dioxide gas can be achieved, are used as the negative electrode.

The present invention can be applied to applications of driving power supplies of mobile information terminals such as mobile phones, notebook personal computers, and personal digital assistants (PDAs), the driving power supplies particularly requiring a high capacity. Furthermore, it is expected that the present invention can also be used in applications in which the operating environment of a battery is severe, e.g., hybrid electric vehicles (HEVs) and electric tools, among high-output applications in which continuous driving at high temperatures is required.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A lithium secondary battery comprising:
a positive electrode comprising a positive electrode current collector and a positive electrode mixture layer including a positive electrode binder and a positive electrode active material containing particles of a lithium transition metal composite oxide represented by a chemical formula LiₐNi_{1-b-c}Co_{b}Al_{c}O₂ (wherein 0<a≦1.1, 0.1≦b≦0.3, and 0.03≦c≦0.10) disposed on a surface of said positive electrode current collector;
a negative electrode including a negative electrode active material containing silicon particles and/or silicon alloy particles;
a separator disposed between the positive electrode and the negative electrode;
a battery case; and
a non-aqueous electrolyte,
the positive electrode, the negative electrode, and the separator constituting an electrode body that is disposed in the battery case,
wherein a lithium-containing oxide having a carbon-dioxide-gas-absorbing capability is adhered to surfaces of the particles of the lithium transition metal composite oxide.

2. The lithium secondary battery according to claim 1, wherein a ratio of the lithium-containing oxide to transition metals in the lithium transition metal composite oxide is 0.1% by mole or more and 1.0% by mole or less.

3. The lithium secondary battery according to claim 1, wherein the lithium-containing oxide is Li₂TiO₃.

4. The lithium secondary battery according to claim 1, wherein the non-aqueous electrolyte contains CO₂.

5. The lithium secondary battery according to claim 1, wherein the silicon particles and/or the silicon alloy particles have an average particle diameter of 7 μm or more and 17 μm or less.

6. The lithium secondary battery according to claim 1, wherein the silicon particles and/or the silicon alloy particles have a crystallite size of 1 nm or more and 100 nm or less.
